(19) United States
(12) Patent Application Publication
(10) Pub. No.: US 2016/0283189 A1
(43) Pub. Date: Sep. 29, 2016

(54) Human Body Coupled Intelligent Information Input System and Method

(71) Applicant: BEIJING XINGYUN SHIKONG TECHNOLOGY CO.,LTD., Beijing (CN)

(72) Inventor: HONGLIANG WANG, BEIJING (CN)

(73) Assignee: BEIJING XINGYUN SHIKONG TECHNOLOGY CO.,LTD., BEIJING (CN)

(21) Appl. No.: 15/033,587

(22) PCT Filed: Jul. 29, 2014
(86) PCT No.: PCT/CN2014/083202

§ 371 Date: Apr. 29, 2016

(30) Foreign Application Priority Data
Nov. 1, 2013 (CN) 201310529685.4

(51) Int. Cl. G06F 3/16; G06F 3/01; G10L 15/22

(52) U.S. Cl. CPC G06F 3/167; G10L 15/22; G06F 3/011; G06F 3/017

(57) ABSTRACT

The present invention discloses a human body coupled intelligent information input system and method. The system comprises: a spatial information sensing unit (101) worn on a predefined position of the human body to obtain three-dimensional spatial information of human body and to send it to a processing unit (103); a clock unit (102) connected to the processing unit (103) for providing temporal information; a processing unit (103) for processing spatial and temporal information of human body and outputting the control instruction to the output unit (104) according to the information; and an output unit (104) for sending the control instruction to the external device. With the system and method according to the present disclosure, accurate localization and complicated control of azimuth, attitude and position of human body can be achieved effectively.

### FIELD OF THE INVENTION

The present invention relates to the network terminal control field, and more particularly relates to a human body coupled intelligent information input system and method.

### BACKGROUND OF THE INVENTION

Traditional network intelligent terminals, i.e. desktop and laptop, are large both in size and weight and undesirable in mobility. In times of mobile internet, mobile intelligent terminals, such as cellphone and tablet PC, are mainly controlled with touch. Due to lack of precision, accurate localization and complicated control can hardly be achieved, thus limiting usage of classic applications of PC like graphics software and Counter Strike on mobile intelligent terminals and hampering popularization of such applications.

Meanwhile, traditional glasses display, controlled with button or touchpad, has low usability, hence similar problems with the above mobile terminals, rendering it difficult to achieve accurate localization and complicated control.

Traditional sensors, such as gyroscope, may achieve position calibration with GPS, which, however, should be implemented in open and non-sheltered places, wherein only two-dimensional horizontal direction can be calibrated while three-dimensional orientation cannot. When gyroscope and other sensors are used in a three-dimensional space for a long time, the cumulative error of the accelerator will be so great that the error keeps magnifying.

Azimuth and attitude sensors on traditional terminals are generally limited for use on a single machine. Worn by people under motion, such as by train, plane, subway, steamer, or by walk, though changes of azimuth and attitude of the apparatus can be detected, the sensors cannot distinguish whether the motion is from the carrier or human body, so that it is impossible to recognize movement of human body normally and achieve control based on the sensors. Furthermore, what the sensors detect are azimuth and attitude changes of the apparatus rather than human body.

Traditional intelligent glasses, though possible for control with voice, require matching between the voice and the vast background corpus. The recognizing process is complicated, inefficient and rather resource-consuming. Meanwhile, due to lack of precise localization and background analysis, it is virtually impossible to achieve overall control. For instance, a third application may be opened with voice, but after that, the application cannot be controlled further.

Traditional mobile intelligent terminals, such as PC and cellphone, Pad, etc., usually take in-ear headphones bond by strings as portable earphones which are prone to form hooks when taken off; some intelligent glasses adopt osteophony earphones to achieve sound transmission via bone vibration. However, to trigger vibration would require more energy, thus incurring greater energy consumption. In addition, osteophony earphones usually have resonance peaks in low or high frequencies which would impact sound quality tremendously, for example, causing poor mega bass effect.

Traditional intelligent glasses, controlled with touchpad or button, would have difficulty in accomplishing efficient input of complicated languages, such as Chinese, and lack efficient user identity authentication mechanism at login. To ensure efficiency, user identity authentication is usually cancelled, which would give rise to information leak risk.

To sum up, the following problems exist in the prior art:

(1) Traditional network intelligent terminals and intelligent glasses have the defect of insufficient control precision, making it difficult to achieve accurate localization and complicated control;

(2) Traditional sensors like gyroscope may adopt GPS position calibration which, however, should be implemented in open and non-sheltered places, wherein only two-dimensional horizontal direction can be calibrated while three-dimensional orientation cannot;

(3) Azimuth and attitude sensors on traditional terminals are generally limited for use on single machine and incapable of distinguishing whether the motion is from the carrier or human body

(4) Traditional intelligent glasses, though possible for control with voice, require matching between the voice and vast background corpus. The recognizing process is complicated, inefficient and rather resource-consuming. Meanwhile, due to lack of precise localization and background analysis, it is virtually impossible to achieve overall control;

(5) Traditional mobile intelligent terminals, such as PC and cellphone, Pad, etc., usually take in-ear headphones bond by string as portable earphones which are prone to form hooks when taken off;

(6) Traditional osteophony earphones have high energy consumption and poor sound effect.

(7) Traditional intelligent glasses, controlled with touchpad or button, would have difficulty in accomplishing efficient input of complicated languages, such as Chinese, and lack efficient user identity authentication mechanism at login. To ensure efficiency, user identity authentication is usually cancelled, which would give rise to information leak risk.

### SUMMARY OF THE INVENTION

The purpose of the present invention is to provide a human body coupled intelligent information input system to achieve dynamic matching of information on azimuth, attitude and time with human body movement so that spatial and temporal information closely coupled with human body can be inputted efficiently and accurately and natural control and precise localization of the software interface can be achieved.

According to an aspect of the present invention, there is provided a human body coupled intelligent information input system comprising: a spatial information sensing unit 101 worn on a predefined position of human body to obtain three-dimensional spatial information of human body and to send it to the processing unit 103; a clock unit 102 connected to the processing unit 103 for providing time information; a processing unit 103 for processing spatial and temporal information of human body and outputting the control instruction to the output unit 104 according to the information; an output unit 104 for sending the control instruction to the external device,

wherein the spatial information comprises information on azimuth, attitude and position of human body.

wherein the spatial information sensing unit 101 comprises: a compass for obtaining azimuth information of human body; a gyroscope for obtaining attitude information of human body; and/or a wireless signal module for obtaining position information of human body.

wherein the wireless signal module obtains position information of human body via at least one of a global positioning system, a cellphone base station and WIFI.

wherein the spatial information sensing unit 101 further comprises at least one of the following: an acceleration sensor, a direction sensor, a magnetic sensor, a gravity sensor, a rotation vector sensor and a linear acceleration sensor.

wherein information on azimuth and attitude of human body comprises: displacement of head and hand in three dimensions of space: comprising front-back displacement, up-down displacement, left-right displacement or a combination of these displacements; angle changes of head and hand, including left-right horizontal rotation, up-down rotation and lateral rotation or a combination of these rotations; and/or an absolute displacement and a relative displacement.

Alternatively, the system further comprises: a voice input unit 105 for receiving and recognizing voice instructions sent by human body and sending it to the processing unit 103 after transferring it into voice signals; and/or an optical acquisition unit for acquiring information on user's eye or skin texture when it is close to the user's body, comparing the information with the stored entry information, thus achieving user identity authentication and login.

wherein the processing unit 103 amends control error with at least one of boundary return mode, control amplifying mode, control accelerating mode, control locking mode, localization focus passive reset mode, localization focus active reset mode and relative displacement control mode, wherein:

The boundary return mode pre-configures error boundary on the display interface, limits movement of the localization focus of the controller within the range of error boundary and implements error amendment when the controller returns.

The control amplifying mode amends control error by amplifying displacement of the controller on the display interface;

In the control accelerating mode, the acceleration of the controller is transmitted to the interface localization focus so that it accelerates movement and achieves control;

In the control locking mode, through locking the interface localization focus corresponding to the controller, the controller returns to amend error;

In the localization focus passive reset mode, the error is amended through driving the passive rest of the localization focus with acceleration of the controller;

In the localization focus active reset mode, the error is amended through active reset of the interface localization focus.

In the relative displacement control mode, motion control is achieved by obtaining relative displacement of a plurality of controllers.

Alternatively, the processing unit 103 under motion analyzes relative motion between different sensors with absolute motion of respective sensor, computes the relative displacement of human body and controls with relative displacement of human body; the processing unit 103 only detects the spatial angle change of the spatial information sensing unit 101 by switching off the displacement mode of the spatial information sensing unit 101 and controls with the angle change; the processing unit 103 achieves recognition and input of the gesture with the spatial information sensing unit 101 disposed in the ring, thus obtaining zooming in, zooming out and browse of the image at all angles; the processing unit 103 achieves rotation of the head and/or recognition and input of the movement with the spatial information sensing unit 101 disposed in the intelligent glasses to obtain zooming in, zooming out and browse of the image at all angles; and/or the spatial information sensing unit 101 analyzes the trace of spatial movement of hands into words to achieve recognition and input of the words.

Alternatively, the processing unit 103 analyses possible controls associated with the controller that the localization focus is in according to the information on the current position of the localization focus and extracts original corpus corresponding to the operation from the base corpus; the processing unit 103 matches and recognizes the obtained voice input signal with the original corpus associated with control of the controller and achieves voice control of the interface corresponding to the current position of the control focus; and/or the processing unit 103 recognizes and processes the voice input signal of the voice input unit 105 according to information on azimuth and attitude of the human body.

According to another aspect of the present invention, there is provided a human body coupled intelligent information input system comprising the following steps: Step S1, obtaining spatial and temporal information of human body; Step S2, processing the spatial and temporal information of human body and outputting the respective control instruction according to the information; Step S3, sending the control instruction to the external device to achieve the operation.

As stated above, the human body coupled intelligent information input system and method according to the present invention have the following marked technical effect: (1) achieving precise localization and complicated control of the apparatus; (2) achieving calibration of the three-dimensional orientation; (3) distinguishing whether the motion is from the carrier or human body; (4) reducing difficulty of voice recognition and achieving overall control with voice; (5) adopting an audio output device of a column or drop shape extending from the lower part of the leg of the glasses to the external auditory canal which is convenient to wear and has desirable sound effect; (6) achieving efficient input of Chinese and other complicated languages; (7) providing an efficient user identity authentication mechanism.

### BRIEF DESCRIPTION OF THE DRAWINGS

FIG. 1 is a schematic diagram of the structure of the human body coupled intelligent information input system according to the present invention;

FIG. 2 is a schematic diagram of the human body coupled intelligent information input system according to the present invention amending control error with a boundary return mode.

FIG. 3 is a schematic diagram of the human body coupled intelligent information input system according to the present invention amending control error with a control amplifying mode.

FIG. 4 is a schematic diagram of the human body coupled intelligent information input system according to the present invention amending control error with a control accelerating mode.

FIG. 5 is a schematic diagram of the human body coupled intelligent information input system according to the present invention amending control error with a localization focus passive reset mode;

FIG. 6 is a schematic diagram of the human body coupled intelligent information input system according to the present invention amending control error with a control locking mode;

FIG. 7 is a schematic diagram of the human body coupled intelligent information input system according to the present invention amending control error with a localization focus active reset mode.

FIG. 8 is a schematic diagram of the human body coupled intelligent information input system according to the present invention amending control error with relative displacement mode;

FIG. 9 is a schematic diagram of the voice recognition mode of the human body coupled intelligent information input system according to the present invention;

FIG. 10 is a flow diagram of the human body coupled intelligent information input method.

### DETAILED DESCRIPTION OF EMBODIMENTS

The present disclosure will now be described with reference to various example embodiments and the accompanying drawings so that the purpose, technical solutions and advantages of the present invention can be clear. It should be appreciated that depiction is only exemplary, rather than to limit the present disclosure in any manner. In addition, depiction of structure and technology known in the prior art is omitted in the following text to avoid potential confusion of concepts of the present disclosure.

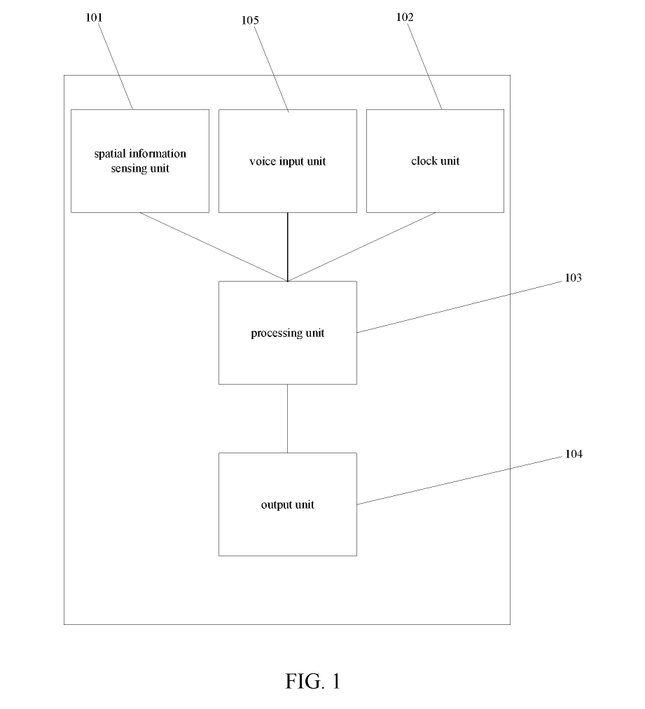

FIG. 1 is a schematic diagram of the structure of the human body coupled intelligent information input system according to the present invention.

As shown in FIG. 1, the human body coupled intelligent information input system according to the present invention comprises a spatial information sensing unit 101, a clock unit 102, a processing unit 103 and an output unit 104.

The spatial information sensing unit 101 is worn on a predefined position of human body to obtain three-dimensional spatial information of human body and to send it to the processing unit 103. The spatial information sensing unit 101 is connected to the processing unit 103. Specifically, the spatial information sensing unit 101 may be configured in the ring worn on hand and/or intelligent glasses worn on head to obtain information on azimuth, attitude and position of human body. For example, the spatial information sensing unit 101 may comprise a compass, a gyroscope, an acceleration sensor and a wireless signal module, etc., wherein the compass, gyroscope and acceleration sensor are used to obtain information on azimuth and attitude of human body which includes: displacement of head and hand in three dimensions of space (comprising front-back displacement, up-down displacement, left-right displacement or a combination of these displacements); angle changes of head and hand (including left-right horizontal rotation, up-down rotation and lateral rotation or a combination of these rotations); absolute displacement and relative displacement. The wireless signal module obtains position information of human body to achieve localization of human body via, for example, at least one of a global positioning system, a cellphone base station and WIFI.

A clock unit 102 is used for providing temporal information. The clock unit 102 is connected to the processing unit 103 and usually implemented as a timer to record time and provide it to the processing unit 103. The clock unit 102 may be configured in the ring worn on hand and/or intelligent glasses worn on head.

A processing unit 103 is used for processing spatial information and temporal information of human body and outputting the respective control instruction to the output unit 104. In the present invention, the processing unit 103 may amend control error with at least one of boundary return mode, control amplifying mode, control accelerating mode, control locking mode, localization focus passive reset mode, localization focus active reset mode and relative displacement control mode.

An output unit 104 is for sending control instruction of the processing unit 103 to the external device. Alternatively, the output unit 104 comprises an audio output device of a column or drop shape extending from the lower part of the leg of the glasses to the external auditory canal.

Alternatively, the system of the present disclosure further comprises a voice input unit 105 for receiving and recognizing voice instructions sent by human body and sending it to the processing unit 103 after transferring it into voice signals.

Alternatively, the system of the present disclosure further comprises an optical acquisition unit for acquiring information on user's eye or skin texture when it is close to the user's body, comparing the information with the stored entry information, thus achieving user identity authentication and login. The optical acquisition unit may be, for example, a camera or an optical scanner.

As stated above, in the human body coupled intelligent information input system of the present invention, the processing unit 103 processes spatial and temporal time of human body obtained via the spatial information sensing unit 101 and the clock unit 102 to achieve dynamic matching of information on azimuth, attitude and time with human body movement so that spatial and temporal information coupled with human body can be inputted efficiently and accurately and natural control and precise localization of the software interface can be achieved.

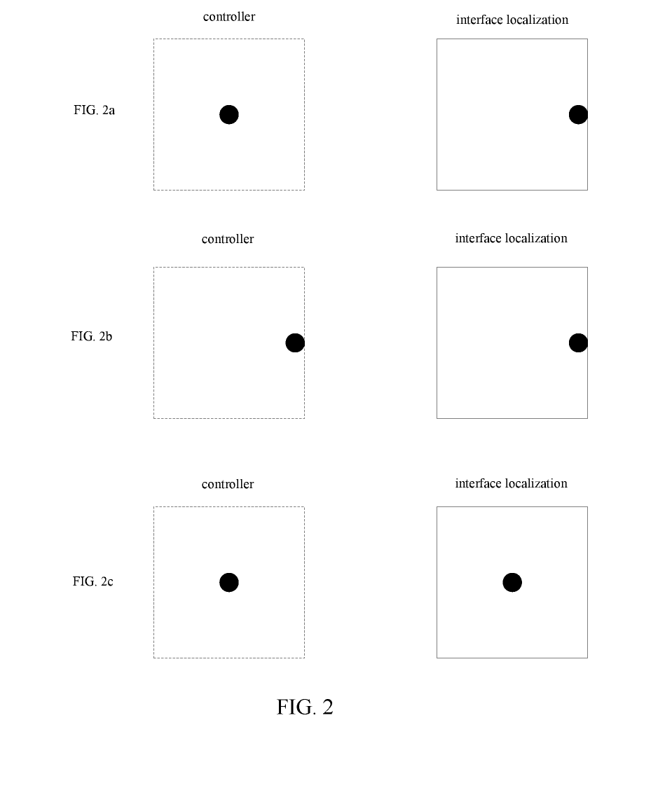

FIG. 2 is a schematic diagram of the human body coupled intelligent information input system according to the present invention amending control error with a boundary return mode.

As shown in FIG. 2, the boundary return mode of the processing unit 103 pre-configures error boundary (e.g. localization boundary of front-back, left-right, and up-down displacement or localization boundary of rotation angle in all directions), so that the localization focus of the controller can only move in the range of the error boundary, thus limiting the error of the controller within the range. When the controller returns, the error may be amended.

As shown in FIG. 2a, when the controller is in the middle of the error boundary, the interface localization focus is already on the right boundary. Then greater error of control to the right will occur.

As shown in FIG. 2b, the operator continues to move in the error direction (i.e. the right side). As an error boundary is set in the display interface, the localization focus of the controller cannot move out of the boundary. In other words, the focus does not change and the controller has moved to the right side of the control interface.

As shown in FIG. 2c, the controller moves to the middle of the boundary (namely, it returns) and the interface localization focus also returns to the middle position. Then the location of the controller and that of the interface localization focus are identical, and thus, the error is amended.

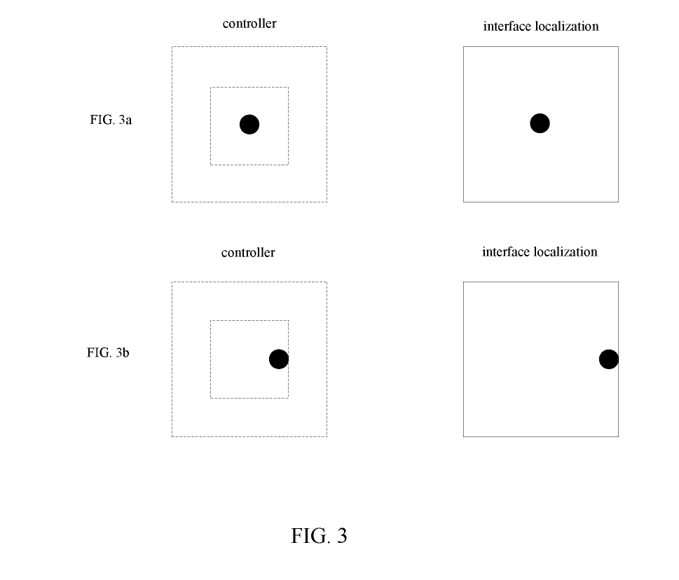

FIG. 3 is a schematic diagram of the human body coupled intelligent information input system according to the present invention amending control error with a control amplifying mode.

As shown in FIG. 3, the operation amplifying mode of the processing unit 103 amends error mainly by amplifying the displacement of the controller on the interface, specifically,

In FIG. 3a, when the controller is in the middle, the interface localization focus is also positioned in the middle of the interface.

In FIG. 3b, the controller moves for a quite short distance and the interface localization focus moves correspondingly for a very long distance. Then greater range of localization of the interface can be achieved within the space that is possible for the controller and the interface operation error can be maintained at a very large range that is possible for control.

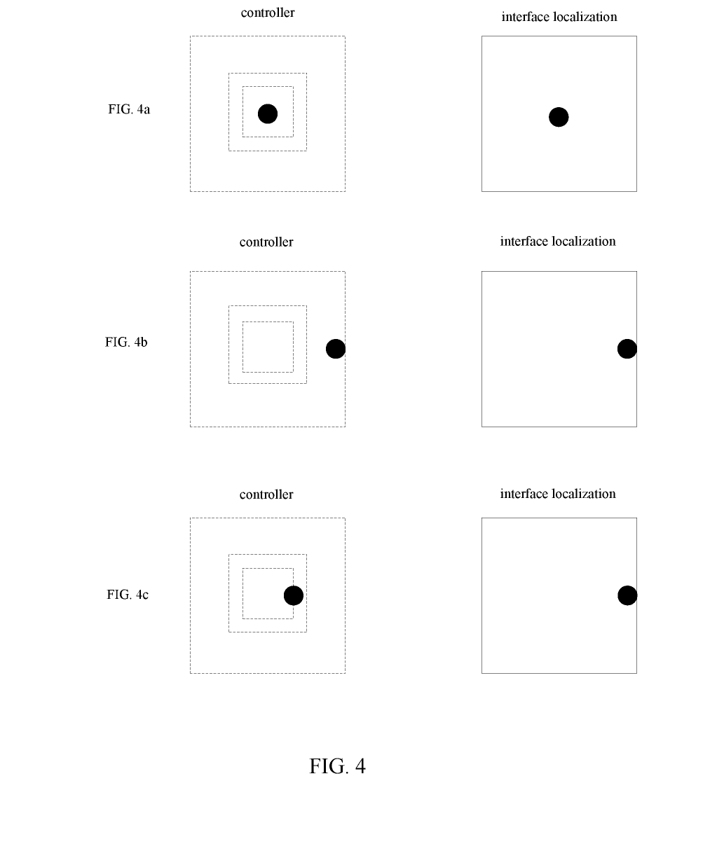

FIG. 4 is a schematic diagram of the human body coupled intelligent information input system according to the present invention amending control error with a control accelerating mode.

As shown in FIG. 4, in the operation accelerating mode of the processing unit 103, the acceleration of the controller is transmitted to the interface localization focus, so that it will accelerate movement to achieve the purpose of control.

In FIG. 4a, when the controller in the middle, the interface localization focus is also in the middle of the interface.

In FIG. 4b, when the controller moves slowly, the interface localization focus moves slowly correspondingly and the localization focus moves without accelerating. Then only when the controller moves for a long distance can the interface localization focus move for the given distance.

In FIG. 4c, with FIG. 4a as the starting position, when the controller moves fast, the interface localization focus accelerates movement. Then the controller only needs to move for a short distance for the interface localization focus to move for the given distance.

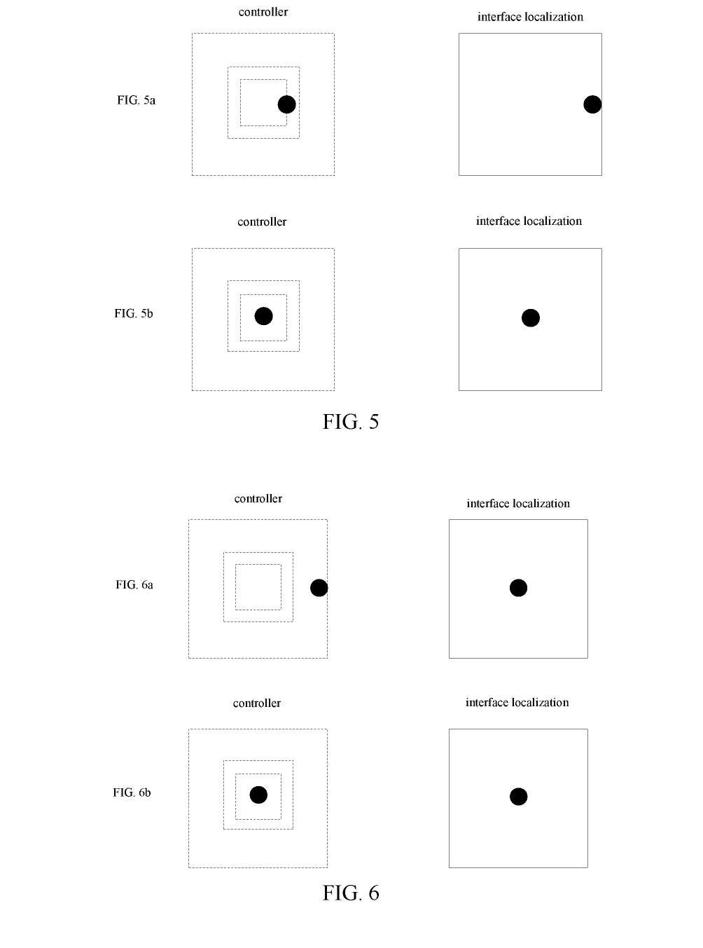

FIG. 5 is a schematic diagram of the human body coupled intelligent information input system according to the present invention amending control error with a localization focus passive reset mode.

As shown in FIG. 5, in the localization focus passive reset mode of the processing unit 103, the error is amended through driving the passive rest of the localization focus when the controller returns with acceleration.

As shown in FIG. 5a, the controller moves to the right for a small displacement and the localization focus moves to the right for a large displacement. Then the localization focus has a great error.

As shown in FIG. 5b, the controller returns with acceleration in the reverse direction, driving the localization focus to return with acceleration in the reverse direction, thus reducing error effectively.

FIG. 6 is a schematic diagram of the human body coupled intelligent information input system according to the present invention amending control error with a control locking mode;

As shown in FIG. 6, in the control locking mode of the processing unit 103, through locking the interface localization focus corresponding to the controller, the controller returns to amend error.

In FIG. 6a, when great error occurs for localization of the localization focus, locking control is executed, namely, the controller moves while the interface localization focus does not move.

In FIG. 6b, after the controller moves to a predefined proper position, it is unlocked. Then the location of the controller and that of the interface localization focus are identical, and thus, the error is amended.

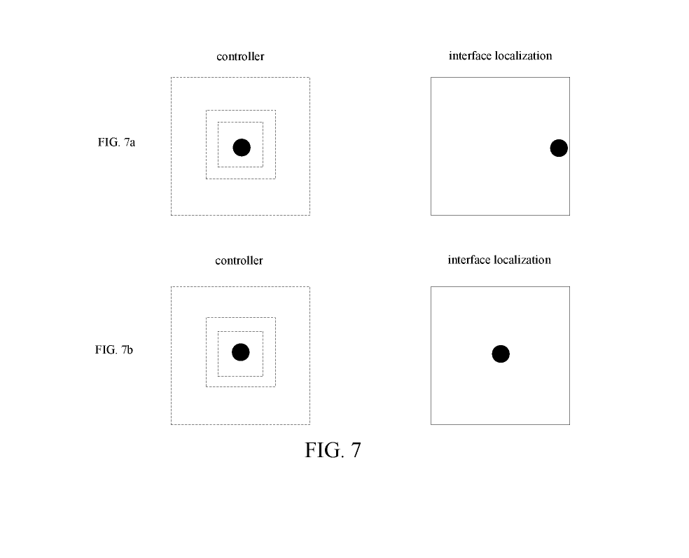

FIG. 7 is a schematic diagram of the human body coupled intelligent information input system according to the present invention amending control error with a localization focus active reset mode.

As shown in FIG. 7, in the localization focus active reset mode of the processing unit 103, the error is amended with the active reset of the interface localization focus.

In FIG. 7a, when the controller is in the middle, the interface localization focus has a great error.

In FIG. 7b, the active reset operation of the interface localization focus is triggered and the interface localization focus returns to the central position of the interface until to the condition as shown in FIG. 7b, thus amending the error. Alternatively, interface dragging may be used so that the interface central position and the localization focus position overlap again until to the condition as shown in FIG. 7b, thus eliminating control error.

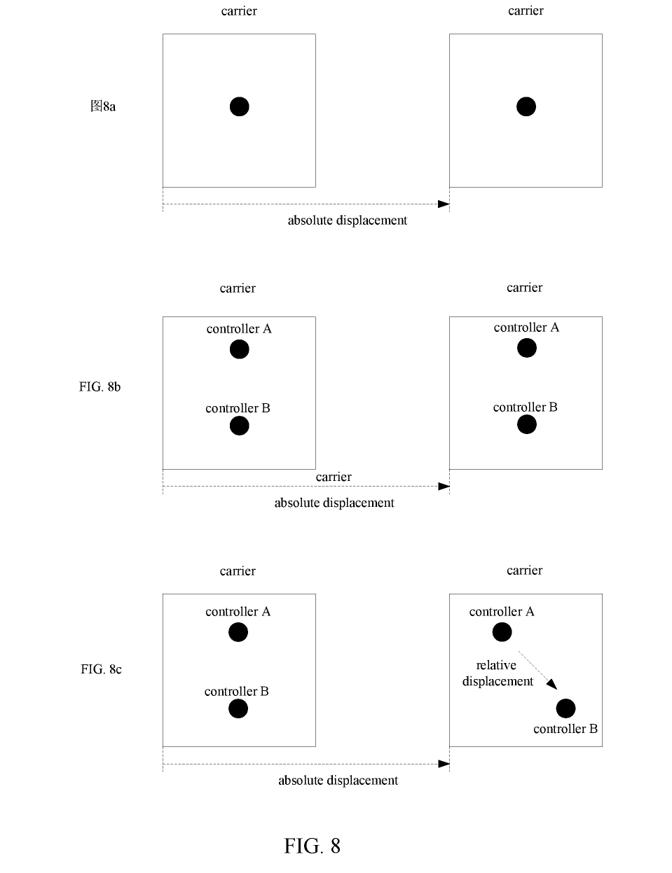

FIG. 8 is a schematic diagram of the human body coupled intelligent information input system according to the present invention with relative displacement control mode;

As shown in FIG. 8, in the relative displacement control mode of the processing unit 103, motion control is achieved by acquiring relative displacement between a plurality of controllers.

In FIG. 8a, under the condition of a single controller, when the carrier moves, only the absolute position of carrier movement is recorded. As absolute displacement and relative displacement cannot be distinguished, it is impossible to achieve effective control.

In FIG. 8b, when two controllers (A and B) exist but do not communicate with each other, as the carrier moves, the two controllers can only record the absolute position of carrier movement respectively. As there is no communication between the two controllers, it is possible to distinguish absolute displacement and the relative displacement and achieve effective control.

In FIG. 8c, two or more controllers in the present invention communicate with each other via the processing unit 103. As the carrier moves, the two controllers can sense displacement change, respectively. The processing unit 103 firstly analyzes the respective absolute displacement of the two controllers and then the relative displacement between the two controllers, thus achieving effective control under motion with relative displacement.

With the above relative displacement control mode, the processing unit 103 under motion can be controlled with relative displacement of the human body; when the carrier moves vigorously, the processing unit 103 may lock the screen and provide some simple operations.

Further, the processing unit 103 under motion may analyze relative movement between different sensors with respective absolute movement, thus computing the relative displacement between different parts of the human body.

Alternatively, the processing unit 103 may switch off the displacement mode of the spatial information sensing unit and only detects the spatial angle change of the spatial information sensing unit and controls with the angle change.

Further, the system of the present invention achieves recognition and input of gesture with the spatial information sensing unit 101 positioned in the ring, for instance, “ticking”, “marking a cross”, “drawing a circle”, etc.. With these natural gestures, confirmation of the frequently used keys, such as “yes”, “no”, “cancel”, etc., can be achieved.

Further, the system of the present invention achieves recognition and input of rotation and/or motion of the head with the spatial information sensing unit 101 disposed in the intelligent glasses.

Further, with the system of the present invention, the image scan function can be achieved. For example, when the system scans the image, the spatial information sensing unit 101 may detect front-back movement and up-down, left-right and lateral rotation of the head. With front-back movement, natural zooming in and zooming out of the image can be achieved; when the image is too large to be fully shown on the display, with up-down, left-right and lateral rotation of the head, the image may be browsed from all angles;

Further, when the system scans the image, the spatial information sensing unit 101 may detect front-back movement and up-down, left-right and lateral rotation of the hand. With front-back movement, natural zooming-in and zooming-out of the image can be achieved; when the image is too large to be fully shown on the display, with up-down, left-right and lateral rotation of the hand, the image may be browsed from all angles;

Further, with the system of the present invention, text input function may be achieved. For example, when word input is executed in the system, the spatial information sensing unit 101 analyzes the trace of spatial movement of hands into words to achieve natural and efficient input of the words.

When the system is close to the user's body, it acquires information on user's eye or skin texture with a camera or an optical scanner and compares the information with the stored entry information, thus achieving efficient user identity authentication and quick login.

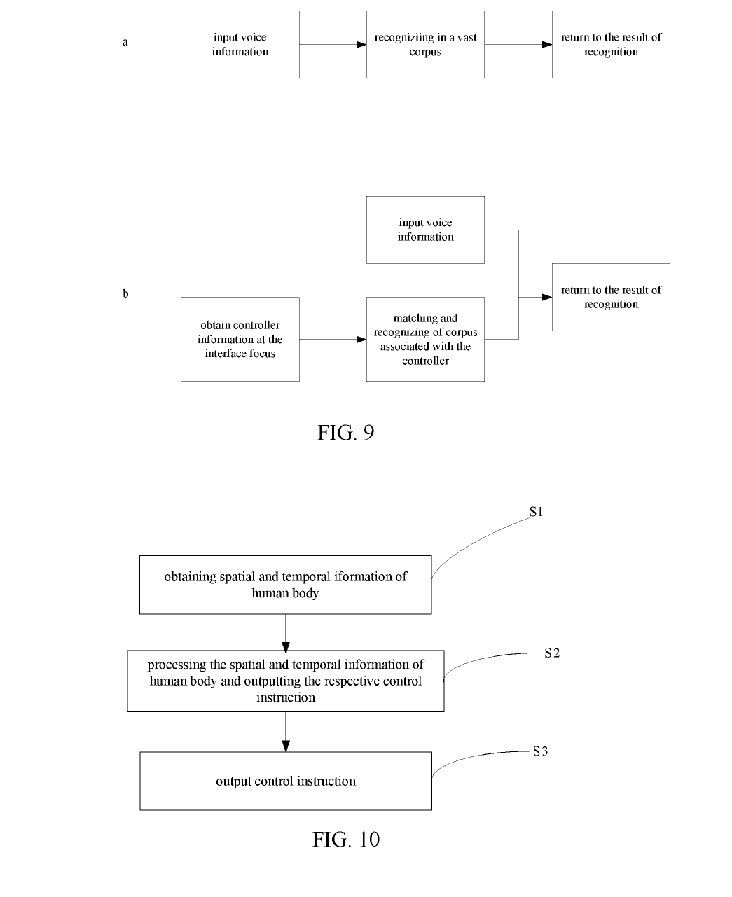

FIG. 9 is a schematic diagram of the voice recognition mode of the human body coupled intelligent information input system according to the present invention.

As stated above, the human body coupled intelligent information input system according to the present invention further comprises a voice input unit 105 for achieving acquisition, transference and transmission of the voice input signal.

FIG. 9a displays the traditional voice recognition mode which requires matching with the vast corpus and recognition. This mode is rather resource-consuming and inefficient with a low level of accuracy.

FIG. 9b illustrates the voice recognition mode of the human body coupled intelligent information input system according to the present invention. Under this mode, the acquired input voice signal is matched with corpus associated with the controller, thus reducing complexity of voice matching dramatically and improving efficiency and accuracy of voice recognition effectively. To be specific, first of all, the processing unit analyses all the possible controls associated with the controller that the focus is in according to the current position of the localization focus corresponding to the controller, then extracts original corpus associated with the controller from the base corpus accurately for matching, comparing and recognizing with the corpus associated with the controller and then returns to the result of recognition.

As stated above, in the present invention, the acquired input voice signal is matched automatically with the original corpus associated with the controller, thus achieving voice control of the interface corresponding to the current position of the control focus. As focus localization and voice control of the respective controller are achieved, the overall control of the software system via the voice can thus be achieved, thereby expanding breadth and depth of voice control effectively.

FIG. 10 is a flow diagram of the human body coupled intelligent information input method.

As shown in FIG. 10, the human body coupled intelligent information input method according to the present invention comprises the following steps:

Step S1, obtaining spatial and temporal information of the human body, specifically, obtaining information on azimuth, attitude and time of the human body with the ring worn on hand and/or intelligent glasses worn on head.

The spatial information of human body comprises information on azimuth and attitude, for example comprising: displacement of head and hand in three dimensions of space: including front-back displacement, up-down displacement, left-right displacement or a combination of these displacements. The spatial information of human body comprises information on position, such as position information of human body obtained via at least one of a global positioning system, a cellphone base station and WIFI.

Step S2, processing the spatial and temporal information of human body and outputting the respective control instruction according to the information. In this step, dynamic matching of information on azimuth, attitude and time with human body movement is achieved by processing the acquired information on azimuth, attitude and time of the human body, so that spatial and temporal information coupled with human body can be inputted efficiently and accurately and natural control and precise localization of the software interface can be achieved. In this step, control error is amended with at least one of boundary return mode, control amplifying mode, control accelerating mode, control locking mode, localization focus active/passive mode.

Step S3, sending the control instruction to the external device to achieve the respective operation.

It should be appreciated that the above detailed embodiments of the present disclosure are only to exemplify or explain principles of the present disclosure and not to limit the present disclosure. Therefore, any modifications, equivalent alternatives and improvement, etc. without departing from the spirit and scope of the present disclosure shall be included in the scope of protection of the present disclosure. Meanwhile, appended claims of the present disclosure aim to cover all the variations and modifications falling under the scope and boundary of the claims or equivalents of the scope and boundary.

What is claimed is:

1. A human body coupled intelligent information input system, comprising:
a spatial information sensing unit worn on a predefined position of the human body to obtain three-dimensional spatial information of human body and to send it to a processing unit,
a clock unit connected to the processing unit for providing temporal information;
a processing unit for processing spatial and temporal information of human body and outputting the control instruction to the output unit according to the information; and
an output unit for sending the control instruction to the external device.

2. The system according to claim 1, wherein the spatial information comprises information on azimuth, attitude and position.

3. The system according to claim 2, wherein the spatial information sensing unit comprises:
a compass for obtaining azimuth information of human body;
a gyroscope for obtaining attitude information of human body; and/or
a wireless signal module for obtaining position information of human body.

4. The system according to claim 3, wherein the wireless signal module obtains position information of human body via at least one of a global positioning system, a cellphone base station and WIFI.

5. The system according to claim 3, wherein the spatial information sensing unit further comprises at least one of the following: an acceleration sensor, a direction sensor, a magnetic sensor, a gravity sensor, a rotation vector sensor and a linear acceleration sensor.

6. The system according to claim 2, wherein information on azimuth and attitude of human body comprises:
displacement of head and hand in three dimensions of space, comprising front-back displacement, up-down displacement, left-right displacement or a combination of these displacements;
angle changes of head and hand, including left-right horizontal rotation, up-down rotation and lateral rotation or a combination of these rotations; and/or
an absolute displacement and a relative displacement.

7. The system according to claim 1, further comprising:
a voice input unit for receiving and recognizing voice instructions sent by human body and sending it to the processing unit after transferring it into voice signals; and/or
an optical acquisition unit for acquiring information on user's eye or skin texture when it is close to the user's body, comparing the information with the stored entry information, thus achieving user identity authentication and login.

8. The system according to claim 1, wherein the processing unit amends control error with at least one of boundary return mode, control amplifying mode, control accelerating mode, control locking mode, localization focus passive reset mode, localization focus active reset mode and relative displacement control mode, wherein:
the boundary return mode pre-configures error boundary on the display interface, limits movement of the localization focus of the controller within the range of error boundary and implements error amendment when the controller returns;
the control amplifying mode amends control error by amplifying displacement of the controller on the display interface;
in the control accelerating mode, the acceleration of the controller is transmitted to the interface localization focus so that it accelerates movement, thus achieving control;
in the control locking mode, through locking the interface localization focus corresponding to the controller, the controller returns to amend error;
in the localization focus passive reset mode, the error is amended through driving the passive rest of the localization focus with acceleration of the controller;
in the localization focus active reset mode, the error is amended through active reset of the interface localization focus.
in the relative displacement control mode, control under motion is achieved by obtaining relative displacement of a plurality of controllers.

9. The system according to claim 8, characterized in that the processing unit under motion analyzes relative motion between different sensors with absolute motion of respective sensor, computes the relative displacement of human body and controls with relative displacement of human body;
the processing unit only detects the spatial angle change of the spatial information sensing unit by switching off the displacement mode of the spatial information sensing unit and controls with the angle change;
the processing unit achieves recognition and input of the gesture with the spatial information sensing unit disposed in the ring, thus obtaining zooming in, zooming out and browse of the image at all angles;
the processing unit achieves recognition and input of rotation and/or motion of the head with the spatial information sensing unit disposed in the intelligent glasses to obtain zooming in, zooming out and browse of the image at all angles; and/or
the spatial information sensing unit analyzes the trace of spatial movement of hands into words to achieve recognition and input of the words.

10. The system according to claim 7, characterized in that
the processing unit analyses all the possible controls associated with the controller that the localization focus is in according to the current position of the localization focus and then extracts original corpus corresponding to the associated control from the base corpus;
the processing unit matches and recognizes the obtained voice input signal with the original corpus associated with control of the controller and achieves voice control of the interface corresponding to the current position of the control focus; and/or
the processing unit recognizes and processes the voice input signal of the voice input unit according to information on azimuth and attitude of the human body.

11. A human body coupled intelligent information input method, comprising the following steps:
step S1, obtaining spatial and temporal information of the human body;
step S2, processing the spatial and temporal information of human body and outputting the respective control instruction according to the information;
step S3, sending the control instruction to the external device to achieve the respective operation.
